(19) United States
(12) Patent Application Publication
(10) Pub. No.: US 2018/0128351 A1
(43) Pub. Date: May 10, 2018

(54) SPLIT TORQUE DUAL CLUTCH TRANSMISSION FOR CONCENTRIC INPUT SHAFTS

(71) Applicant: Gregory Mordukhovich, Bloomfield Hills, MI (US)

(72) Inventor: Gregory Mordukhovich, Bloomfield Hills, MI (US)

(21) Appl. No.: 15/343,350

(22) Filed: Nov. 4, 2016

(51) Int. Cl. F16H 3/093; F16H 3/00

(52) U.S. Cl. CPC F16H 3/093; F16H 2200/0052; F16H 3/006

(57) ABSTRACT

A dual clutch transmission includes a housing, a first clutch configured to selectively couple a first input shaft to a transmission input shaft to transfer torque therebetween, and a second clutch configured to selectively couple a second input shaft to the transmission input shaft to transfer torque therebetween. A clutch connector is movable between a disengaged position and an engaged position. In the disengaged position, the first and second clutches are uncoupled and configured to transfer the torque from the transmission input shaft to their respective first or second input shaft independently of each other. In the engaged position, the first and second clutches are coupled for common rotation to utilize a torque transfer capacity of both first and second clutches by transferring the torque from the transmission input shaft through both first and second clutches to only one of the first and second input shafts.

### FIELD

The present application relates generally to dual clutch transmissions and, more particularly, to a dual clutch transmission with selectively coupleable clutches.

### BACKGROUND

Transmissions are provided in motor vehicles in many configurations for providing speed-changing gears between an engine and a drive axle. One such example is a dual dry clutch transmission. In general, a dual dry clutch transmission includes a pair of gearboxes operating in parallel, each with its own clutch and allowing for the selection and engagement of subsequent gears. The dual dry clutch transmission provides engagement of subsequent gears while the prior gear remains engaged. In one configuration, a dual dry clutch transmission includes a dual clutch housing that is supported in a transmission housing by a support bearing.

In some operating scenarios, an extended clutch slip may be implemented for dual clutch transmission drivability, performance, and/or user satisfaction. However, such extended clutch slip may lead to a potential high heat scenario associated with the dual clutch transmission frictional interfaces, which may cause potentially undesirable NVH and/or drivability situations. Thus, while these dual clutch transmissions work well for their intended purpose, there is a desire for improvement in the relevant art.

### SUMMARY

In accordance with an aspect of the disclosure, a dual clutch transmission is provided. In one exemplary implementation, the transmission includes a housing, a first clutch configured to selectively couple a first input shaft to a transmission input shaft to transfer torque therebetween, and a second clutch configured to selectively couple a second input shaft to the transmission input shaft to transfer torque therebetween. A clutch connector is movable between a disengaged position and an engaged position. In the disengaged position, the first and second clutches are uncoupled and configured to transfer the torque from the transmission input shaft to their respective first or second input shaft independently of each other. In the engaged position, the first and second clutches are coupled for common rotation to utilize a torque transfer capacity of both first and second clutches by transferring the torque from the transmission input shaft through both first and second clutches to only one of the first and second input shafts.

In accordance with another aspect of the disclosure, a vehicle is provided. The vehicle includes an engine configured to output torque to a transmission input shaft, and a dual clutch transmission configured to selectively couple to the transmission input shaft. The dual clutch transmission includes, in one exemplary implementation, a housing, a first clutch configured to selectively couple a first input shaft to the transmission input shaft to transfer torque therebetween, and a second clutch configured to selectively couple a second input shaft to the transmission input shaft to transfer torque therebetween. A clutch connector is movable between a disengaged position and an engaged position. In the disengaged position, the first and second clutches are uncoupled and configured to transfer the torque from the transmission input shaft to their respective first or second input shaft independently of each other. In the engaged position, the first and second clutches are coupled for common rotation to utilize a torque transfer capacity of both first and second clutches by transferring the torque from the transmission input shaft through both first and second clutches to only one of the first and second input shafts.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example dry dual clutch transmission in accordance with the principles of the present application; and

FIG. 2 is a cross-sectional view of an example wet dual clutch transmission in accordance with the principles of the present application.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed implementations and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure

### DESCRIPTION

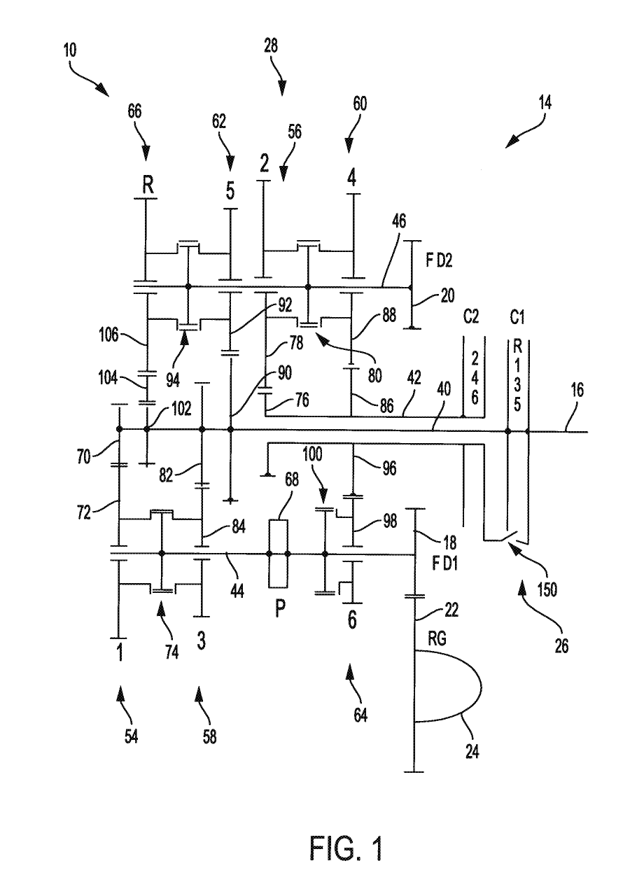

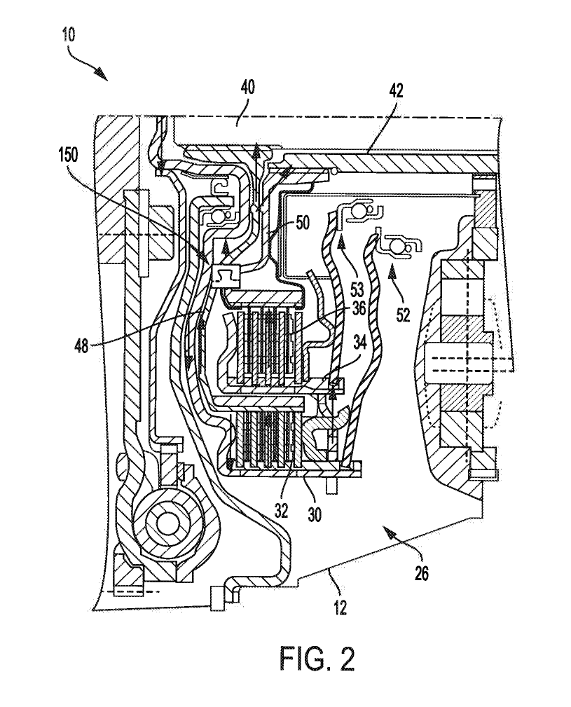

With reference to FIGS. 1 and 2, a dual clutch transmission constructed in accordance with one example of the present disclosure is shown and generally identified at reference numeral 10. FIG. 1 illustrates dual clutch transmission 10 in a dry clutch configuration, and FIG. 2 illustrates dual clutch transmission 10 in a wet clutch configuration. However, the principles of operation described herein are substantially similar regardless of wet or dry configuration. In the example embodiment, dual clutch transmission 10 generally includes a transmission housing 12 that supports a dual clutch assembly 14. Transmission 10 includes a transmission input shaft 16, and output gears 18, 20 operably coupled to a ring gear 22 of a differential 24. Input shaft 16 is coupled to an engine (not shown) to provide a driving torque to input shaft 16. Output gears 18, 20 are each configured to rotatably drive differential 24 to thereby transfer the torque to a pair of road wheels (not shown). Although illustrated as a six-speed dual clutch transmission, it will be appreciated that other gearing arrangements for achieving other speeds may be employed. Moreover, while FIG. 2 illustrates dual clutch assembly 14 as a wet clutch configuration, it will be appreciated that dual clutch assembly 14 is not so limited and may also be a dry clutch configuration as shown in FIG. 1.

The dual clutch assembly 14 generally includes a clutch portion 26 and a transmission portion 28. The clutch portion 26 receives a rotatable input from transmission input shaft 16 and transfers the rotatable motion to the transmission portion 28. The transmission portion 28 includes a plurality of gear sets configured to convert the rotational output from the clutch portion 26 to rotation of output gears 18, 20, in various gear ratios.

In the example embodiment, clutch portion 26 is coupled between transmission input shaft 16 and transmission portion 28, and generally includes a first or odd clutch C1 and a second or even clutch C2. With additional reference to FIG. 2, clutch C1 includes a first drive clutch 30 and one or more clutch disks 32, and clutch C2 includes a second drive clutch 34 and one or more clutch disks 36. Drive clutches 30, 34 are configured to couple to input shaft 16 for common rotation therewith. Clutch disks 32, 36 (e.g., friction disks) are interleaved with their respective drive clutch 30, 34 to form a friction clutch. For example, drive clutches 30, 34 and clutch disks 32, 36 each include friction plates configured to interact with each other and form the friction clutch.

In the example embodiment, transmission portion 28 generally includes a first input or inner shaft 40, a second input or outer shaft 42, a first countershaft 44, and a second countershaft 46. Outer shaft 42 is hollow and inner shaft 40 is concentrically disposed therein. Inner shaft 40 is coupled to clutch disks 32 of clutch C1 via an arm 48 (FIG. 2) and is configured for rotation therewith, while outer shaft 42 is coupled to clutch disks 36 of clutch C2 via an arm 50 (FIG. 2) and is configured for rotation therewith. Countershafts 44, 46 are spaced apart from and parallel to inner shaft 40 and outer shaft 42. As such, input shafts 40, 42 define a first axis of rotation, countershaft 44 defines a second axis of rotation, and countershaft 46 defines a third axis of rotation.

As shown in FIG. 2, a first or odd actuator 52 is configured to selectively engage clutch C1, and a second or even actuator 53 is configured to selectively engage clutch C2. In the illustrated embodiment, actuators 52, 53 are electromechanical actuators. However, it will be appreciated that actuators 52, 53 may be other types of actuators such as, for example, hydraulic actuators. As such, selective engagement of clutch C1 connects input shaft 16 for common rotation with inner shaft 40, and selective engagement of clutch C2 connects input shaft 16 for common rotation with outer shaft 42. Moreover, as will be described herein in more detail, clutch portion 26 includes a clutch connector 150 configured to selectively couple clutches C1 and C2 such that engine input torque is split between clutches C1 and C2 and subsequently combined again at the clutch connector 150.

With continued reference to FIG. 1, in the example embodiment, clutch portion 26 further includes a first gear set 54, a second gear set 56, a third gear set 58, a fourth gear set 60, a fifth gear set 62, a sixth gear set 64, a reverse gear set 66, and a parking gear 68.

First gear set 54 forms a transmission gear structure for a first forward gear ‘1’ and generally includes an input pinion gear 70 and an output gear 72. Input pinion gear 70 is rotatably fixed to inner shaft 40 for common rotation therewith. Output gear 72 is meshingly engaged with input pinion gear 70 and is selectively coupleable to countershaft 44 via a synchronizer device 74 to transfer torque to countershaft 44. In the example embodiment, synchronizer device 74 is a double sided synchronizer and generally includes an actuator (not shown) configured to selectively translate a shifting mechanism (not shown) to move synchronizer device 74 between an engaged position and a disengaged position. For example, synchronizer device 74 is configured to selectively couple output gear 72 to countershaft 44 for rotation therewith.

Second gear set 56 forms a transmission gear structure for a second forward gear 2′ and generally includes an input pinion gear 76 and an output gear 78. Input pinion gear 76 is rotatably fixed to outer shaft 42 for common rotation therewith. Output gear 78 is meshingly engaged with input pinion gear 76 and is selectively coupleable to countershaft 46 via a synchronizer device 80 to transfer torque to countershaft 46. In the example embodiment, synchronizer device 80 is a double sided synchronizer and is similarly configured to move between an engaged position and a disengaged position to selectively couple output gear 78 to countershaft 46 for rotation therewith.

Third gear set 58 forms a transmission gear structure for a third forward gear ‘3’ and generally includes an input pinion gear 82 and an output gear 84. Input pinion gear 82 is rotatably fixed to inner shaft 40 for common rotation therewith. Output gear 84 is meshingly engaged with input pinion gear 82 and is selectively coupleable to countershaft 44 via synchronizer device 74 to transfer torque to countershaft 44.

Fourth gear set 60 forms a transmission gear structure for a fourth forward gear ‘4’ and generally includes an input pinion gear 86 and an output gear 88. Input pinion gear 86 is rotatably fixed to outer shaft 42 for common rotation therewith. Output gear 88 is meshingly engaged with input pinion gear 86 and is selectively coupleable to countershaft 46 via synchronizer device 80 to transfer torque to countershaft 46.

Fifth gear set 62 forms a transmission gear structure for a fifth forward gear ‘5’ and generally includes an input pinion gear 90 and an output gear 92. Input pinion gear 90 is rotatably fixed to inner shaft 40 for common rotation therewith. Output gear 92 is meshingly engaged with input pinion gear 90 and is selectively coupleable to countershaft 46 via a synchronizer device 94 to transfer torque to countershaft 46. In the example embodiment, synchronizer device 94 is a double sided synchronizer and is similarly configured to move between an engaged position and a disengaged position to selectively couple output gear 92 to countershaft 46 for rotation therewith.

Sixth gear set 64 forms a transmission gear structure for a sixth forward gear ‘6’ and generally includes an input pinion gear 96 and an output gear 98. Input pinion gear 96 is rotatably fixed to outer shaft 42 for common rotation therewith. Output gear 98 is meshingly engaged with input pinion gear 96 and is selectively coupleable to countershaft 44 via a synchronizer device 100 to transfer torque to countershaft 44. In the example embodiment, synchronizer device 100 is a single sided synchronizer and is similarly configured to move between an engaged position and a disengaged position to selectively couple output gear 98 to countershaft 44 for rotation therewith.

Reverse gear set 66 forms a transmission gear structure for a reverse gear ‘R’ and generally includes an input pinion gear 102, an idler gear 104, and an output gear 106. Input pinion gear 102 is rotatably fixed to inner shaft 40 for common rotation therewith, and idler gear 104 is meshingly engaged between input pinion gear 102 and output gear 106. Output gear 106 is meshingly engaged with idler gear 104 and is selectively coupleable to countershaft 46 via synchronizer device 94 to transfer torque to countershaft 46.

As shown in FIG. 1, first final drive gear 18 is rotatably fixed to countershaft 44 for common rotation therewith. Final drive gear 18 is meshingly engaged with ring gear 22 to transfer torque to the differential 24. Similarly, second final drive gear 20 is rotatably fixed to countershaft 46 for common rotation therewith. Final drive gear 20 is meshingly engaged with ring gear 22 to transfer torque to the differential 24. Final drive gears 18, 20 are configured to transfer torque delivered by countershafts 44, 46 to differential 24, which outputs the torque to the vehicle road wheels. Parking gear 68 is rotatably fixed to countershaft 44 and is configured to prevent ring gear 22 from rotating when the transmission is placed in a parking mode.

In general operation, dual clutch transmission 10 provides six forward torque ratios and one reverse torque ratio each having a unique speed ratio associated with each torque ratio. Each of the forward gears and the reverse gear are obtained by selective actuation of clutches C1, C2 and synchronizers 74, 80, 94, 100. However, it will be appreciated that dual clutch transmission 10 may include additional or fewer gear sets to provide additional or fewer torque ratios.

With continued reference to FIGS. 1 and 2, the clutch connector 150 will be described in more detail. In the example embodiment, clutch connector 150 is a mechanical or frictional connection between odd clutch C1 and even clutch C2. In one example, clutch connector 150 is a friction clutch configured to selectively engage clutches C1 and C2 for common rotation. In another example, clutch connector 150 is a synchronizer device configured to selectively engage clutches C1 and C2 for common rotation. As such, clutch connector 150 is configured to move between a disengaged position and an engaged position.

In the disengaged position, clutch connector 150 does not couple clutches C1 and C2 together such that clutches C1 and C2 are rotatable relative to each other (e.g., arms 48, 50 are movable relative to each other). In this way, dual clutch transmission 10 operated in a standard manner known in the art where a separate torque path is delivered separately through each clutch C1, C2.

However, in the engaged position, clutch connector 150 couples clutches C1 and C2 together for common rotation (e.g., arms 48, 50 are locked together for common rotation). In this way, the input torque from input shaft 16 is split and delivered through both clutches C1 and C2 and subsequently recombined through clutch connector 150. By simultaneously utilizing the torque capacity of both clutches C1, C2 for a specific gear, extended clutch slip is allowed from the input to the desired gear without overheating the frictional interfaces of each clutch C1, C2. In this way, no additional gears are needed and damper size is reduced. Moreover, the combined torque connection is configured to be activated (engaged) to support a specific gear for a limited time (e.g., during a vehicle launch or a passing maneuver), and then deactivated to allow pre-section of the next desired gear. Accordingly, clutch connector 150 is configured to be moved to the engaged position when the energy capacity of a single clutch C1 or C2 is not sufficient for smooth torque transfer, to improve drivability. Although shown as located in a specific location in FIG. 2 between arms 48, 50, it will be appreciated that clutch connector 150 may connect the torque path at any location throughout dual clutch assembly 14.

An example operation of dual clutch transmission 10 utilizing clutch connector 150 in the engaged position for the first through sixth gears will be described. However, it will be appreciated that clutch connector 150 is configured to be selectively moved to the engaged position for any combination of the forward/reverse gears of dual clutch transmission 10.

To establish the first forward gear ‘1’, synchronizer device 74 is activated to connect output gear 72 to countershaft 44. Each clutch C1, C2 is engaged to input shaft 16 and clutch connector 150 is engaged to couple clutches C1 and C2. Alternatively, one of clutches C1, C2 and clutch connector 150 are engaged, and the other of clutches C1, C2 is subsequently engaged. Either way, both clutches C1, C2 will slip and transfer torque until full engagement is achieved. As such, clutch C1 couples input shaft 16 and inner shaft 40, clutch connector 150 couples clutch C2 to clutch C1, and synchronizer device 74 couples output gear 72 to countershaft 44. Input torque from input shaft 16 is transferred through both clutches C1 and C2 to inner shaft 40. Input pinion gear 70 then transfers the torque from shaft 40 to output gear 72, through synchronizer device 74, and to countershaft 44 and final drive gear 18. The torque is then transferred to ring gear 22.

To establish the second forward gear 2′, synchronizer device 80 is activated to connect output gear 78 to countershaft 46. Each clutch C1, C2 is engaged and connector 150 is engaged to couple clutches C1 and C2.

Alternatively, one of clutches C1, C2 and clutch connector 150 are engaged, and the other of the clutches C1, C2 is subsequently engaged. As such, clutch C2 couples input shaft 16 and outer shaft 42, clutch connector 150 couples clutch C1 to clutch C2, and synchronizer device 80 couples output gear 78 to countershaft 46. Input torque from input shaft 16 is transferred through both clutches C1 and C2 to outer shaft 42. Input pinion gear 76 then transfers the torque from shaft 42 to output gear 78, through synchronizer device 80, and to countershaft 46 and final drive gear 20. The torque is then transferred to ring gear 22.

To establish the third forward gear ‘3’, synchronizer device 74 is activated to connect output gear 84 to countershaft 44. Each clutch C1, C2 is engaged and clutch connector 150 is engaged to couple clutches C1 and C2. Alternatively, one of clutches C1, C2 and clutch connector 150 are engaged, and the other of the clutches C1, C2 is subsequently engaged. As such, clutch C1 couples input shaft 16 and inner shaft 40, clutch connector 150 couples clutch C2 to clutch C1, and synchronizer device 74 couples output gear 84 to countershaft 44. Input pinion gear 82 then transfers the torque from shaft 40 to output gear 84, through synchronizer device 74, and to countershaft 44 and final drive gear 18. The torque is then transferred to ring gear 22.

To establish the fourth forward gear ‘4’, synchronizer device 80 is activated to connect output gear 88 to counter shaft 46. Each clutch C1, C2 is engaged and clutch connector 150 is engaged to couple clutches C1 and C2. Alternatively, one of clutches C1, C2 and clutch connector 150 are engaged, and the other of clutches C1, C2 is subsequently engaged. As such, clutch C2 couples input shaft 16 and outer shaft 42, clutch connector 150 couples clutch C1 to clutch C2, and synchronizer device 80 couples output gear 88 to countershaft 46. Input pinion 86 then transfers the torque from shaft 42 to output gear 88, through synchronizer device 80, and to countershaft 46 and final drive gear 20. The torque is then transferred to ring gear 22.

To establish the fifth forward gear ‘5’, synchronizer device 94 is activated to connect output gear 92 to countershaft 46. Each clutch C1, C2 is engaged and clutch connector 150 is engaged to couple clutches C1 and C2. Alternatively, one of clutches C1, C2 and clutch connector 150 are engaged, and the other of clutches C1, C2 is subsequently engaged. As such, clutch C1 couples input shaft 16 and inner shaft 40, clutch connector 150 couples clutch C2 to clutch C1, and synchronizer device 94 couples output gear 92 to countershaft 46. Input pinion gear 90 then transfers the torque from shaft 40 to output gear 92, through synchronizer device 94, and to countershaft 46 and final drive gear 20. The torque is then transferred to ring gear 22.

To establish the sixth forward gear ‘6’, synchronizer device 100 is activated to connect output gear 98 to countershaft 44. Each clutch C1, C2 is engaged and clutch connector 150 is engaged to couple clutches C1 and C2. Alternatively, one of clutches C1, C2 and clutch connector 150 are engaged, and the other of clutches C1, C2 is subsequently engaged. As such, clutch C2 couples input shaft 16 and outer shaft 42, clutch connector 150 couples clutch C1 to clutch C2, and synchronizer device 100 couples output gear 98 to countershaft 44. Input pinion gear 96 then transfers torque from shaft 42 to output gear 98, through synchronizer device 100, and to countershaft 44 and final drive gear 18. The torque is then transferred to ring gear 22.

To establish the reverse gear ‘R’, synchronizer device 94 is activated to connect output gear 106 to countershaft 46, and clutch C1 is engaged. As such, clutch C1 couples input shaft 16 and inner shaft 40, and synchronizer device 94 couples output gear 106 to countershaft 46. Input pinion gear 102 then transfers torque from shaft 40, to idler gear 104, and subsequently to output gear 106. The torque is then transferred through synchronizer device 94, to countershaft 44 and final drive gear 20, and then to ring gear 22.

Described herein are systems and methods for a dual clutch transmission having split torque between even and odd clutches coupled to concentric shafts. A clutch connector selectively couples the even and odd clutches to split the input torque between the two clutches and subsequently recombines the torque through the clutch connector. The connection is configured to be activated to support a specific gear for specific situation such as a vehicle launch or passing, and then subsequently deactivated to enable normal operation. Simultaneously utilizing the torque capacity of both even and odd clutches allows for extended clutch slip from the input shaft to the desired gear without overheating the frictional interfaces of the clutches, thereby providing smooth gear engagement and increased drivability without additional gear assemblies.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A dual clutch transmission comprising:
a housing;
a first clutch configured to selectively couple a first input shaft to a transmission input shaft to transfer torque therebetween;
a second clutch configured to selectively couple a second input shaft to the transmission input shaft to transfer torque therebetween; and
a clutch connector movable between a disengaged position and an engaged position, wherein in the disengaged position the first and second clutches are uncoupled and configured to transfer the torque from the transmission input shaft to their respective first or second input shaft independently of each other, and wherein in the engaged position the first and second clutches are coupled for common rotation to utilize a torque transfer capacity of both first and second clutches by transferring the torque from the transmission input shaft through both first and second clutches to only one of the first and second input shafts.

2. The dual clutch transmission of claim 1, wherein when the clutch connector is in the engaged position, torque is transferred from the transmission input shaft and delivered through both the first and the second clutches, the torque being subsequently recombined via the clutch connector and delivered to one of the first and second input shafts.

3. The dual clutch transmission of claim 1, wherein the first clutch is a friction clutch having a first drive clutch configured to couple to the transmission input shaft for common rotation therewith, and a first plurality of friction disks coupled to the first input shaft via a first arm for common rotation with the first input shaft, and
wherein the second clutch is a friction clutch having a second drive clutch configured to couple to the transmission input shaft for common rotation therewith, and a second plurality of friction disks coupled to the second input shaft via a second arm for common rotation with the second input shaft.

4. The dual clutch transmission of claim 3, wherein in the engaged position, the clutch connector couples the first arm and the second arm.

5. The dual clutch transmission of claim 1, wherein the first and second input shafts are concentric, the first input shaft disposed within the second input shaft.

6. The dual clutch transmission of claim 1, wherein the clutch connector is a friction clutch.

7. The dual clutch transmission of claim 1, wherein the clutch connector is a synchronizer device.

8. The dual clutch transmission of claim 1, further comprising:
a first countershaft having a first final drive gear configured to drive a differential ring gear; and
a second countershaft having a second final drive gear configured to drive the differential ring gear;
three forward gear sets coupled between the first input shaft and the first countershaft; and
three forward gear sets coupled between the second input shaft and the second countershaft.

9. A vehicle comprising:
an engine configured to output torque to a transmission input shaft; and
a dual clutch transmission configured to selectively couple to the transmission input shaft, the dual clutch transmission comprising:
a housing;
a first clutch configured to selectively couple a first input shaft to the transmission input shaft to transfer torque therebetween;
a second clutch configured to selectively couple a second input shaft to the transmission input shaft to transfer torque therebetween; and
a clutch connector movable between a disengaged position and an engaged position, wherein in the disengaged position the first and second clutches are uncoupled and configured to transfer the torque from the transmission input shaft to their respective first or second input shaft independently of each other, and wherein in the engaged position the first and second clutches are coupled for common rotation to utilize a torque transfer capacity of both first and second clutches by transferring the torque from the transmission input shaft through both first and second clutches to only one of the first and second input shafts.

10. The vehicle of claim 10, wherein when the clutch connector is in the engaged position, torque is transferred from the transmission input shaft and delivered through both the first and the second clutches, the torque being subsequently recombined via the clutch connector and delivered to one of the first and second input shafts.

11. The vehicle of claim 9, wherein the first clutch is a friction clutch having a first drive clutch configured to couple to the transmission input shaft for common rotation therewith, and a first plurality of friction disks coupled to the first input shaft via a first arm for common rotation with the first input shaft, and
wherein the second clutch is a friction clutch having a second drive clutch configured to couple to the transmission input shaft for common rotation therewith, and a second plurality of friction disks coupled to the second input shaft via a second arm for common rotation with the second input shaft.

12. The vehicle of claim 10, wherein in the engaged position, the clutch connector couples the first arm and the second arm.

13. The vehicle of claim 9, wherein the first and second input shafts are concentric.

14. The vehicle of claim 9, wherein the clutch connector is a friction clutch.

15. The vehicle of claim 9, wherein the clutch connector is a synchronizer device.

16. The vehicle of claim 9, wherein the first input shaft is an inner shaft and the second input shaft is an outer shaft, the inner shaft disposed within the outer shaft.

17. The vehicle of claim 16, wherein the dual clutch transmission further comprises:
a first countershaft having a first final drive gear configured to drive a differential ring gear;
a second countershaft having a second final drive gear configured to drive the differential ring gear;
a first forward gear set coupled between the inner shaft and the first countershaft;
a second forward gear set coupled between the outer shaft and the second countershaft;
a third forward gear set coupled between the inner shaft and the first countershaft;
a fourth forward gear set coupled between the outer shaft and the second countershaft;
a fifth forward gear set coupled between the inner shaft and the second countershaft; and
a sixth forward gear set coupled between the outer shaft and the first countershaft.

18. The vehicle of claim 17, wherein the first gear set includes a first pinion gear fixed to the inner shaft, and a first output gear meshingly engaged with the first pinion gear;
wherein the second gear set includes a second pinion gear fixed to the outer shaft, and a second output gear meshingly engaged with the second pinion gear;
wherein the third gear set includes a third pinion gear fixed to the inner shaft, and a third output gear meshingly engaged with the third pinion gear;
wherein the fourth gear set includes a fourth pinion gear fixed to the outer shaft, and a fourth output gear meshingly engaged with the fourth pinion gear;
wherein the fifth gear set includes a fifth pinion gear fixed to the inner shaft, and a fifth output gear meshingly engaged with the fifth pinion gear;
wherein the sixth gear set includes a sixth pinion gear fixed to the outer shaft, and a sixth output gear meshingly engaged with the sixth pinion gear.

19. The vehicle of claim 18, wherein the dual clutch transmission further comprises:
a first synchronizer device configured to (i) selectively couple the first output gear and the first countershaft, and (ii) selectively couple the third output gear and the first countershaft;
a second synchronizer device configured to (i) selectively couple the second output gear and the second countershaft, and (ii) selectively couple the fourth output gear and the second countershaft;
a third synchronizer device configured to selectively couple the fifth output gear and the second countershaft; and
a fourth synchronizer device configured to selectively couple the sixth output gear and the first countershaft.
